(19) United States
(12) Patent Application Publication
(10) Pub. No.: US 2021/0024032 A1
(43) Pub. Date: Jan. 28, 2021

(54) RANGE ADJUSTABLE CHILD SEAT ALERT SYSTEM

(71) Applicant: Future Concepts LLC, Jacksonville, FL (US)

(72) Inventor: Luke Edwards, Middleburg, FL (US)

(21) Appl. No.: 16/520,888

(22) Filed: Jul. 24, 2019

(51) Int. Cl. B60R 22/48; B60N 2/28

(52) U.S. Cl. CPC B60R 22/48; B60N 2002/981; B60N 2002/2815; B60N 2/2812

(57) ABSTRACT

A range adjustable child seat alert system includes a seat module with clasp and receptacle members that releasably lock together by buckling and each of which receives a shoulder strap of a child seat. A circuit attached to the receptacle member contains a transceiver and microcontroller, determines if the seat module is buckled and sets an output power for a limited communication range for the transceiver. The range is limited to the vicinity of the child seat. If a fob does not receive a communication from the circuit while the seat module is buckled, then the fob produces an alarm.

### FIELD OF THE INVENTION

This invention relates generally to alert systems for vehicles, and, more particularly, to a system for alerting individuals of children left unattended in a vehicle.

### BACKGROUND

Occasionally, drivers negligently leave valuables in their vehicles. Perishable foods may create a mess or odor, which can often be remediated. However, when the valuable is a child, the consequences may be tragic. For mothers and fathers who have unintentionally left their child in a car, the aftermath couldn't be much worse. First and foremost, their child may have died. Second, they caused it. And third, the tragedy was completely preventable.

Various systems have been devised to alert drivers to children left in a vehicle. Many of these systems require complex sensors and/or switches and logic to detect the presence of a child. For example, a system may include a switch or sensor (e.g., weight sensor) on a seat or a seat belt. When the seat is occupied or the seat belt is fastened, the system concludes that a child has been placed in the seat. A predetermined time after the vehicle has been turned off and/or the driver's door has been open and closed, the system may determine that the child has been left behind. Some systems attempt to determine distance between the driver and the child seat using an RF signal. For example, a fob possessed by the driver may periodically emit a wireless signal of limited range. A receiver at the child seat may expect to receive the wireless signal. If the signal is not received when scheduled to be received, one or more times, the system determines that a child has been left behind. In such case an alarm is emitted. The alarm may be a text (SMS) message communicated to a phone via cellular network communication, an audible alarm, or a flashing light.

A problem with such systems is unreliability. A driver may park in a driveway or garage of his or her home. Even within the home, the fob may be within communication range of a unit associated with the child seat. In such a case, an alarm is not generated because the fob and in-car unit remain in communication. The consequence may be tragic.

Range cannot be determined in a manufacturing facility. Factors that affect range include receiver sensitivity, antenna shape, antenna gain, antenna directionality, how clear the path between transmitter and receiver are, orientation of the antenna, data rate, and interference with other signals within the same frequency spectrum, among other factors. Of these factors, the path and interference are purely a function of the particular environment, meaning that they vary from home to home.

The range of a child detection system should be configurable. A range that is too short will result in false alarms as a driver walks around a vehicle to retrieve a child. A range that is too long may result in a tragedy.

The invention is directed to overcoming one or more of the problems and solving one or more of the needs as set forth above.

### SUMMARY OF THE INVENTION

To solve one or more of the problems set forth above, in an exemplary implementation of the invention, a range adjustable child seat alert system is provided. The range adjustable child seat alert system includes a seat module with clasp and receptacle members that releasably lock together by buckling and each of which receives a shoulder strap of a child seat. A circuit attached to the receptacle member contains a transceiver and microcontroller, determines if the seat module is buckled and sets an output power for a limited communication range for the transceiver. The range is limited to the vicinity of the child seat. If a fob does not receive a communication from the circuit while the seat module is buckled, then the fob produces an alarm.

The seat module is attachable to a pair of shoulder straps of a child seat. The seat module includes a clasp member having a clasp body with a sideways H-shaped opening for receiving one strap of the pair of straps of the child seat. A receptacle member in which the clasp member is releasably locked includes a receptacle body with a sideways H-shaped opening for receiving the other strap of the pair of straps of the child seat. A first circuit is attached (directly or indirectly) to the receptacle member. The first circuit includes a first transceiver having a variable output power and a first microcontroller operably coupled to the transceiver. The first microcontroller sets an output power for the transceiver. The output power determines an effective range of communication. The first microcontroller provides messages to be transmitted by the first transceiver.

The first circuit also includes a detection device (e.g., a switch or sensor) operably coupled to the first microcontroller. The device detects when the clasp member is releasably locked in the receptacle member.

The fob, i.e., fob module, includes a second circuit. The second circuit includes a second transceiver capable of receiving messages communicated from the first transceiver within the effective communication range, and a second microcontroller operably coupled to the second transceiver. The second microcontroller determines time, if a message is received by the second transceiver from the first transceiver, and whether an output should be produced.

Range of communication is limited to avoid continued communication to an area outside the immediate vicinity of a car seat. For example, if a car is parked outside a residence and communication reaches into the residence, the consequence may be tragic. An alarm may never be produced because the fob is within communication range of the seat module even when laid down in a residence. In one implementation, the output power for an effective communication range that is less than an excessive range is indicated by a user. An input means may be used for indicating the excessive range. Alternatively, the first microcontroller may set the output power for an effective communication range that is less than an excessive range determined by location of the fob module by a user. Thus, the fob module may be positioned just outside the effective (safe) communication range. Then the microcontroller may cycle through output power settings until a setting for a range that does not reach the fob is determined. In one embodiment the seat module and fob each include an input means, such as a button, that is coupled to their respective microcontroller and may be activated (e.g., pressed) simultaneously to initiate a range limiting process. After the fob is positioned just outside a desired range, the button on the seat module may be pressed again to cause the microcontroller of the seat module to cycle through power output settings until a safe setting is determined. The safe setting will not reach the fob when the fob is located outside the desired range.

An audible alarm device operably coupled to the second microcontroller emits an audible alarm if the clasp member is releasably locked in the receptacle member and the second microcontroller determines that a message is not received by the second transceiver from the first transceiver within a determined time period.

The microcontrollers monitor battery charge status (e.g., by monitoring voltage) and produce a signal to indicate charge status as acceptable, will soon require a replacement battery, or unacceptable. Each device may be equipped with an RGD LED module to visibly indicate battery charge status.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a perspective view of a child seat equipped with an exemplary range adjustable child seat alert system according to principles of the invention; and

FIG. 2 is a front view of an exemplary range adjustable child seat alert system according to principles of the invention; and

FIG. 3 is a side view of an exemplary range adjustable child seat alert system according to principles of the invention; and

FIG. 4 is a perspective view of an exemplary range adjustable child seat alert system according to principles of the invention; and

FIG. 5 is a front view of an exemplary unbuckled range adjustable child seat alert system according to principles of the invention; and

FIG. 6 is a perspective view of an exemplary unbuckled range adjustable child seat alert system according to principles of the invention; and

FIG. 7 is a perspective view of an exemplary unbuckled range adjustable child seat alert system with an exposed uncovered circuit according to principles of the invention; and

FIG. 8 is a perspective view of an exemplary portable module, referred to herein as a fob, for communicating with the exemplary range adjustable child seat alert system according to principles of the invention; and

FIG. 9 is a perspective view of an exemplary fob with an exposed uncovered circuit for communicating with the exemplary range adjustable child seat alert system according to principles of the invention; and

FIG. 10 is a high level block diagram of a circuit for an exemplary range adjustable child seat alert system according to principles of the invention; and

FIG. 11 is a high level block diagram of a circuit for an exemplary fob according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the specific components, configurations, shapes, relative sizes, ornamental aspects or proportions as shown in the figures.

### DETAILED DESCRIPTION

The invention includes a portable module, referred to herein as a fob, and a range adjustable child seat module. The fob and seat module each contain circuitry, each of which includes a microcontroller and a transceiver, among other components. When the seat module is closed (i.e., buckled) a sensor or switch in the seat module detects the closure and causes the seat module to awaken. The awakened seat module then sends a pairing message to the fob. Once paired with the fob, the seat module will periodically (e.g., x times per second or once every y seconds) wirelessly communicate a monitoring packet to the fob. When seat module is opened (i.e., unbuckled), the sensor or switch in the seat module detects the unbuckling and causes the seat module to send a message notifying the fob to deactivate the link and return to sleep. Such unbuckling corresponds to removing a child from a child seat. If, after the seat module is closed (i.e., buckled), but before the seat module is opened, the fob does not receive a monitoring packet for more than 2 seconds from the last monitoring packet, then the fob activates an alarm. This would happen if the fob is beyond the wireless communication range of the seat module, and would indicate that a user forgot a child in the child seat.

A user may configure the range of the seat module. The output power of the transceiver in the seat module is variable, which affects range. A value of the variable may be specified by a user by an input means such as a switch (e.g., a DIP switch such as a two row four pin DIP switch, a button or some other switch), or another control such as a dial, or by communicating a value to the seat module 100 using a remote computing device, such as a smartphone. A user may limit the power output, to limit the range to an area in the immediate vicinity of the vehicle. Doing so helps ensure that the communication link is broken when the user moves outside the area. This guards against continued communication when the fob is inside a structure, such as a home or office.

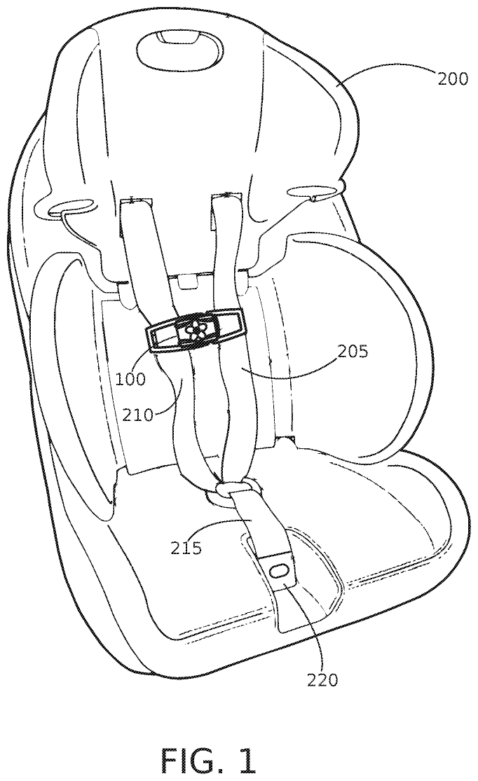

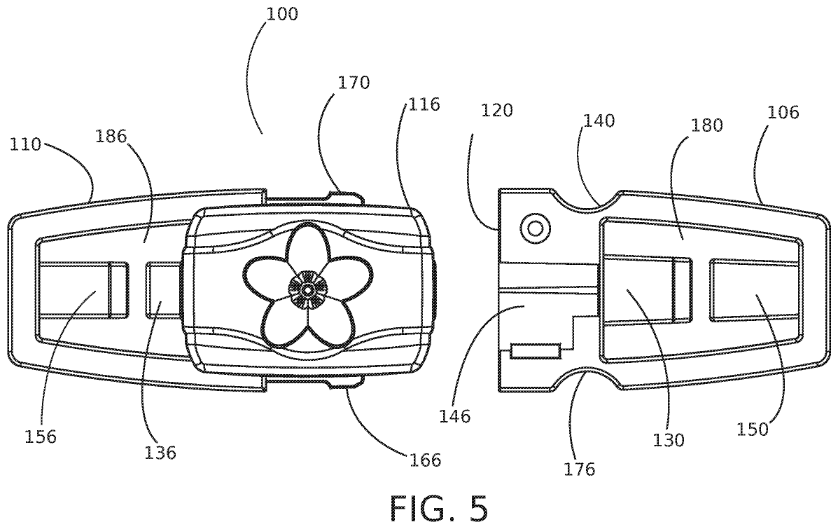

Referring to FIG. 1, a perspective view of a child seat 200 equipped with an exemplary seat module 100 according to principles of the invention is provided. The child seat 200 includes a pair of shoulder straps 205, 210 and a crotch strap 215, for a 3-point harness In a 5-point harness embodiment, the seat would further include a pair of hip straps. A seat module 100 according to principles of the invention connects to the shoulder straps 205, 210. In FIG. 1, the seat module 100 is shown in a buckled configuration, which is the configuration when the seat 200 is occupied by a child. To remove a child from the seat 200, the seat module 100 is unbuckled by separating the clasp member 110 from the receptacle member 105, as shown in FIG. 5.

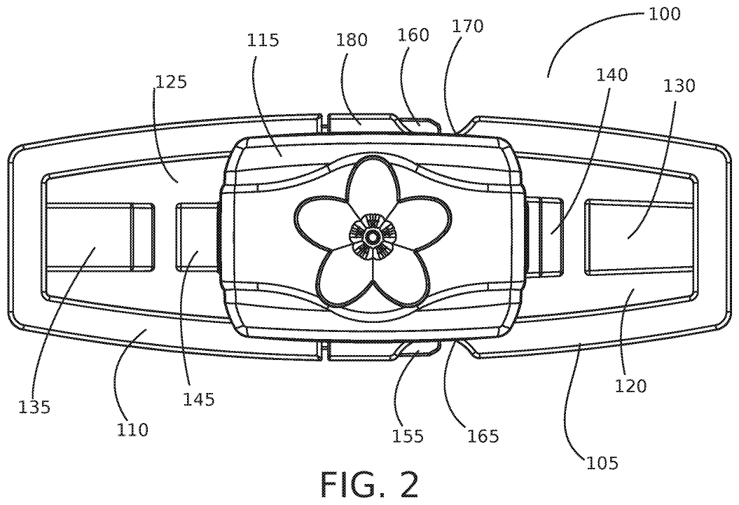

FIG. 2 provides a front view of the seat module 100 in a buckled configuration. The seat module 100 includes a receptacle member 105 and a clasp member 110. The clasp member 110 plugs into the receptacle member 105. Each of the receptacle member 105 and clasp member 110 includes a strap retainer, comprised of an H-shaped opening 120, 125 defined by a pair of spaced-apart aligned tabs 130, 140, and 135, 145. An engaged portion of a shoulder strap 205, 210 may be slid between the aligned tabs 130, 140, and 135, 145 to overlay the tabs 130, 140, and 135, 145, as illustrated in FIG. 1.

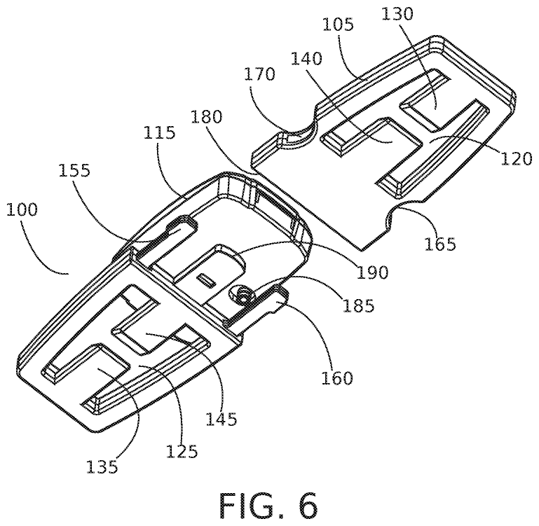

Mating ends of the receptacle member 105 and clasp member 110 include a receptacle 180 with opposed slots (i.e., apertures) 165, 170 and a pair of resilient arms including locking tabs 155, 160 for releasably engaging the opposed slots 165, 170 in the receptacle 180. The structure and operation of these components of the seat module is discussed below with reference to FIGS. 5 and 6.

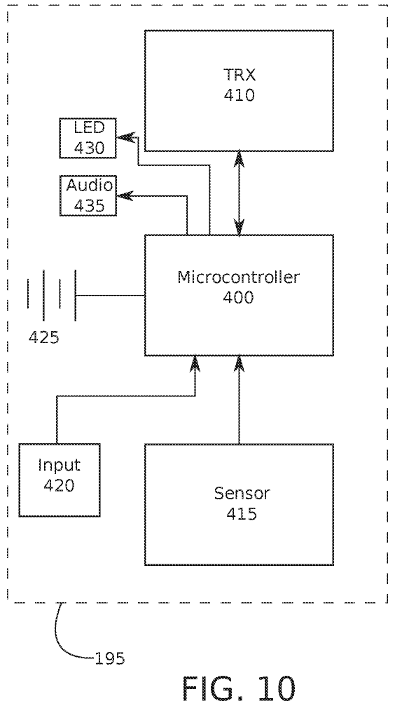

A housing with a removable cover 115 contains circuit components of the seat module 100. The circuit components include, inter alia, a microcontroller, a switch or sensor, and a transceiver. The circuit is discussed below with reference to FIG. 10.

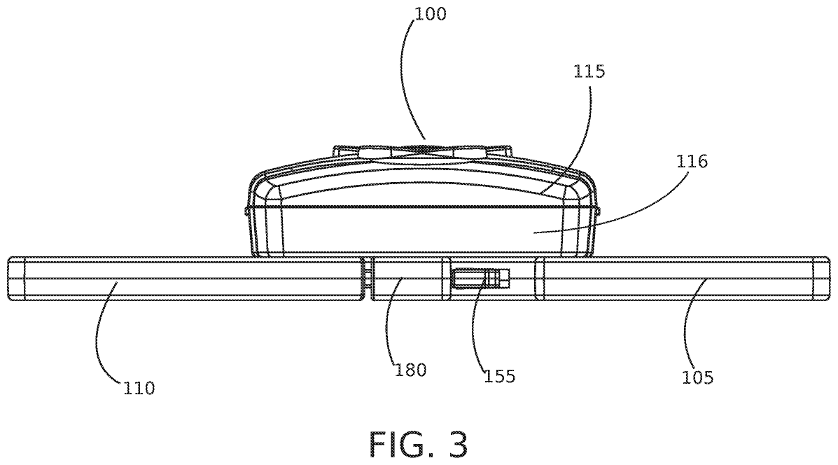

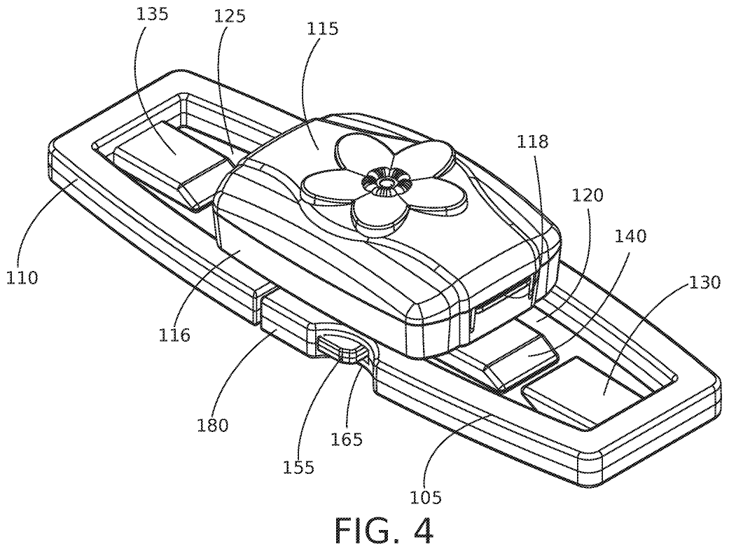

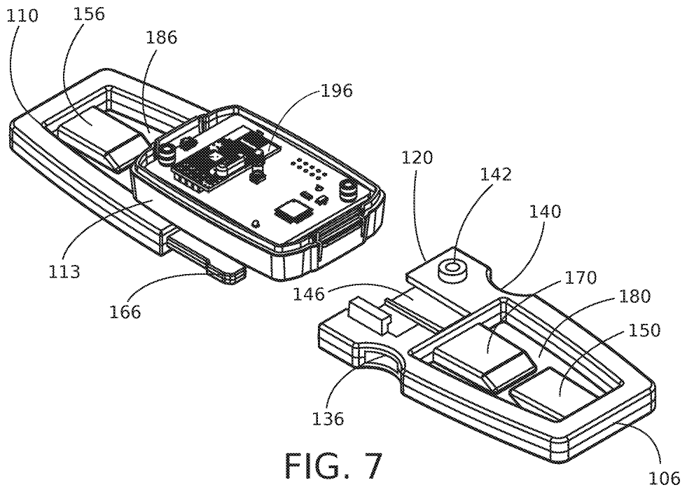

FIG. 3 is a side view of the exemplary seat module 100 for a range adjustable child seat alert system according to principles of the invention. In this view, as in FIGS. 4 and 7, a bottom portion 116 of the housing is visible. The top portion 115 of the housing is preferably attached to the bottom portion 116 via snap fit attachments or mechanical fasteners (e.g., screws). In the perspective view of FIG. 4, a notch 118 to facilitate prying the top portion 115 from the bottom portion 116.

FIG. 4 is a perspective view of the exemplary seat module 100 for the range adjustable child seat alert system according to principles of the invention. In this view, the notch 118 for prying the top portion 115 of the housing from the bottom portion 116 of the housing. Opening the housing allows access to the contained circuit for replacement of batteries and installing, inspecting, adjusting and repairing the circuit.

FIG. 5 is a front view of the exemplary seat module 100, in an unbuckled configuration, for the range adjustable child seat alert system according to principles of the invention. The receptacle member 105 includes a receptacle 180 with a central channel 175 and opposed slots (i.e., apertures) 165, 170. In the perspective view of FIG. 6, the pair of resilient arms including locking tabs 155, 160 for releasably engaging the opposed slots 165, 170 in the receptacle 180 are visible. A central guide 190 for sliding into the central channel 175 is also visible. The central guide 190 maintains alignment and enhances joint strength between the receptacle member 105 and the clasp member 110. To lock the buckle, the locking tabs 155, 160 are inserted into the receptacle 180 until they engage the opposed slots 165, 170. To unlock the buckle, the locking tabs 155, 160 are squeezed together to dislodge them from the opposed slots 165, 170. Then the clasp member 110 may be separated from the receptacle member 105.

A switch or sensor 185 detects when the clasp member 110 is inserted into the receptacle member 105. A switch may be compressed (i.e., depressed) or deflected by a cooperating portion of the receptacle member 105 upon insertion of the clasp member 110 into the receptacle member 105. A sensor may detect the presence of a sensible object (e.g., a magnet) attached to the receptacle member 105.

FIG. 7 is a perspective view of the exemplary seat module 100, in an unbuckled configuration with the top cover 115 removed. The circuit 195 discussed below is conceptually illustrated. A cooperating element 178 (e.g., magnet or protuberance to actuate switch) is shown.

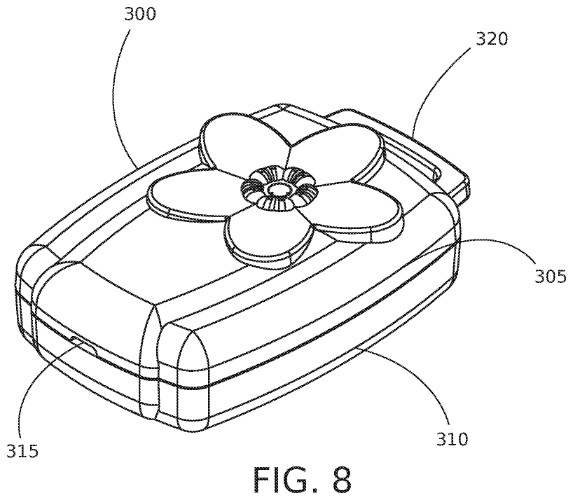

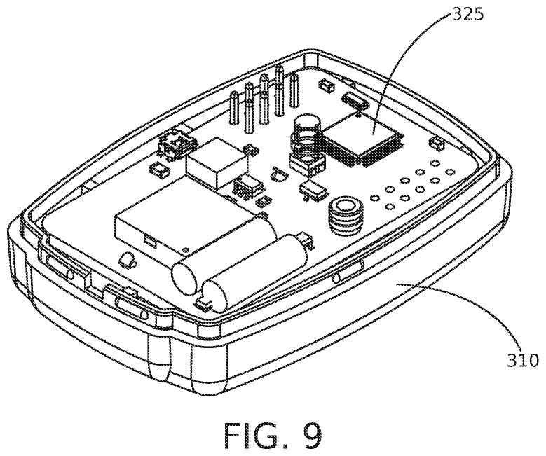

FIG. 8 is a perspective view of an exemplary portable module, referred to herein as a fob 300, for communicating with the exemplary range adjustable child seat alert system according to principles of the invention. The fob 3200 includes upper and lower housing portions 305, 310, a notch to facilitate separation 315, and a key or strap ring 320. The fob contains a circuit 325, as shown in FIG. 9. The circuit 325 of the fob 300 communicates with the circuit 195 of the seat module 100.

FIG. 10 is a high level block diagram of a circuit 195 for an exemplary seat module 100 for a range adjustable child seat alert system according to principles of the invention. The circuit includes a switch or sensor 415 operably coupled to a microcontroller 400, a transceiver 410 operably coupled to the microcontroller 400, and an input device 420 operably coupled to the microcontroller. One or more visible and audio output devices, such as an LED 430 and a speaker (e.g., an active magnetic buzzer 435) may also be coupled to the microcontroller 400 to indicate status.

The sensor 415 (or switch) detects buckle closure, i.e., when the clasp member 110 is received in the receptacle member 105. The sensor 415 may comprise a magnetic sensor attached to the receptacle member 105 and a magnet attached to the clasp member 110. In another embodiment, a protuberance on the clasp member 110 trips a switch in the receptacle member 105 when the buckle is closed. Output from the sensor 415 is provided to the microcontroller 400.

The microcontroller 400 uses output from the sensor 415 to determine a status (opened or closed). If the buckle is opened, the microcontroller 400 implements a mode that applies when the seat module 100 is not in use. For example, the microcontroller 400 may implement sleep mode. If the buckle is opened, the microcontroller 400 implements a mode that applies when the seat module 100 is in use. For example, the microcontroller 400 may implement active mode.

An input device 420, such as an interface (e.g., universal serial bus) or button, allows user input to the microcontroller 400. Such input may be used to activate and/or configure the seat module 400.

In an exemplary embodiment, the data is communicated wirelessly, i.e., via radio frequency communication, from the transceiver 410 included in the circuit 195 to the remote fob module 300. In a particular preferred embodiment, a short range RF communication module and protocol are used to accomplish communication with the remote computing device. By way of example and not limitation, the transceiver 410 is a Bluetooth Low Energy (BLE) module.

A nonlimiting example of a suitable transceiver is the Nordic Semiconductor nRF24L01 single chip 2.4 GHz transceiver with an embedded baseband protocol engine, designed for ultra low power wireless applications in the world wide ISM frequency band at 2.400-2.4835 GHz. Such a transceiver allows selecting an output power setting to limit communication range and power consumption. A PA (power amplifier) control is used to set the output power from a Nordic Semiconductor nRF24L01 transceiver. In transmit mode, PA control has four programmable steps set by a variable (RF_PWR bits) in a register (RF_SETUP). By way of example and not limitation, the four settings are: 00 for the lowest power setting (RF output power of −18 dBm), 01 for the next power setting (RF output power of −12 dBm), 10 for the next power setting (RF output power of −6 dBm), and 11 for the highest power setting (RF output power of 0 dBm). Also by way of example and not limitation, the DC current consumption from the lowest to the highest power output setting may be 7.0 mA, 7.5 mA, 9.0 mA and 11.3 mA, respectively. Thus increased power output requires increased DC current consumption.

A nonlimiting example of a suitable microcontroller is a Nordic 8051 CPU. Such a microcontroller and the transceiver may be separate but operably coupled components, or may be implemented as a single integrated circuit. By way of example, the Nordic Semiconductor nRF24LU1+ includes an integrated transceiver and CPU.

The circuit 195 also includes a battery 425. The battery 425 may be rechargeable or disposable. In the case of a rechargeable battery, the circuit may include a wired interface (e.g., universal serial bus) for recharging, which may also be used for data communication. Additionally, in the case of a rechargeable battery the circuit 195 may also include a battery charging circuit to prevent overcharging the rechargeable battery. The battery 425 supplies power to the circuit 195.

The microcontroller 400 may include drivers to supply output to an LED 430 and an audio device 435. The audible and visible output may indicate selections made by a user, alarm conditions (e.g., low battery), pairing status (i.e., paired, not paired), operating mode (e.g., awake and active) and any other information pertaining to use, configuration and operation.

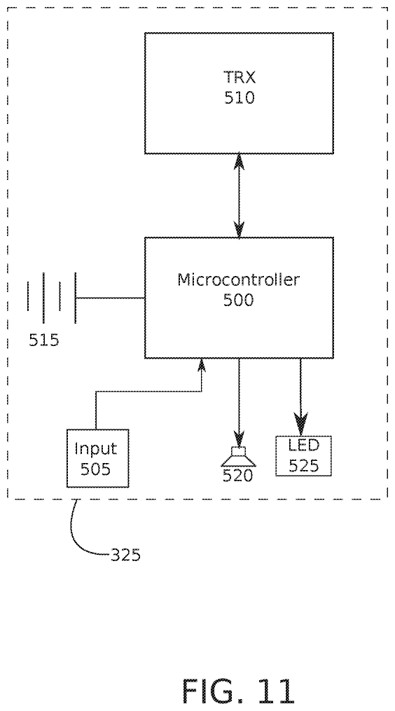

FIG. 11 is a high level block diagram of a circuit 325 for an exemplary fob 300 according to principles of the invention. The exemplary circuit 325 is similar to the circuit 195 for the seat module 100, with the exception of the sensor 415 or switch. The circuit 325 includes a transceiver 510 operably coupled to the microcontroller 500, and an input device 505 operably coupled to the microcontroller. One or more visible and audio output devices, such as a speaker 520 (e.g., an active magnetic buzzer) and an LED 525 may also be coupled to the microcontroller 400 to indicate status.

The microcontroller 400 uses input from the transceiver 510 to determine a status (opened or closed). If the buckle is opened, the microcontroller 500 implements a mode that applies when the seat module 100 is not in use. For example, the microcontroller 500 may implement sleep mode. If the buckle is opened, the microcontroller 500 implements a mode that applies when the seat module 100 is in use. For example, the microcontroller 500 may implement active mode.

An input device 505, such as an interface (e.g., universal serial bus) or button, allows user provide input to the microcontroller 500. Such input may be used to activate and/or configure the fob 300.

In an exemplary embodiment, the data is communicated wirelessly, i.e., via radio frequency communication, to and/or from the transceiver 510 included in the circuit 325 to the remote seat module 100. In a particular preferred embodiment, a short range RF communication module and protocol are used to accomplish communication with the remote computing device. By way of example and not limitation, the transceiver 410 is a Bluetooth Low Energy (BLE) module.

A nonlimiting example of a suitable transceiver is the Nordic Semiconductor nRF24L01 single chip 2.4 GHz transceiver with an embedded baseband protocol engine, designed for ultra low power wireless applications in the world wide ISM frequency band at 2.400-2.4835 GHz. A nonlimiting example of a suitable microcontroller is a Nordic 8051 CPU. Such a microcontroller and transceiver may be separate but operably coupled components, or implemented as a single integrated circuit, as in a Nordic Semiconductor nRF24LU1+ integrated transceiver and CPU.

The circuit 195 also includes a battery 515. The battery 515 may be rechargeable or disposable. In the case of a rechargeable battery, the circuit may include a wired interface (e.g., universal serial bus) for recharging, which may also be used for data communication. Additionally, in the case of a rechargeable battery the circuit 325 may also include a battery charging circuit to prevent overcharging the rechargeable battery. The battery 515 supplies power to the circuit 325.

The microcontroller 500 may include drivers to supply output to an LED 525 and an audio device 520. The audible and visible output may indicate selections made by a user, alarm conditions (e.g., low battery), pairing status (i.e., paired, not paired), operating mode (e.g., awake and active) and any other information pertaining to use, configuration and operation.

The exemplary fob module 300 has three states or modes of operation. They are sleep, monitor active and alarm. In sleep mode the fob module 300 wakes from sleep after a determined time period (e.g., every second) to listen for a message from seat module 100 to enter monitor active mode. The seat module 100 will send a message (i.e., a pairing message) to enter monitor active mode if and when the seat module 100 is closed (i.e., buckled). If no such message is received by the fob module 300, the fob module 300 goes back to sleep for another determined time period (e.g., a second). This cycle of wake-sleep continues unless and until the fob module 300 receives a message from seat module to enter Monitor Active mode. If the fob module 300 receives a message (i.e., pairing message) from seat module to enter monitor active mode, the circuit 325 of the fob module 300 engages with the circuit 195 of the seat module 100 for continuous monitoring. If, while in monitor active mode, more than a determined period of time (e.g., 2 seconds) passes from the last message received from the seat module 100, the fob module 300 enters alarm mode and emits an alarm. The alarm may be visible (e.g., illuminated or flashing LED) and audible. Upon opening (i.e., unbuckling) the seat module 100, the alarm is deactivated and the fob module 300 returns to sleep mode.

The exemplary seat module 100 has three modes of operation. They are sleep, pairing, and link-active. The seat module 100 remains in sleep mode while the seat module is opened (i.e., unbuckled). When the seat module 100 is closed (i.e., buckled) the seat module 100 enters pairing mode. In pairing mode, the seat module 100 sends a pairing message to the fob module 300. Upon successful pairing, the seat module 100 will be engaged with fob module 300 for continuous monitoring in link active mode. Such continuous monitoring entails periodically sending messages (e.g., 2 monitoring packets per second) to the fob module 300. When seat module is opened (i.e., unbuckled), the seat module sends a message to the fob module notifying the fob module 300 it is now safe to deactivate the link and go back to sleep.

In an exemplary embodiment, battery level alerts are provided. During pairing mode, battery level is measured on both the fob module 300 and seat module 100. Voltage thresholds for three levels may be set. A lowest voltage threshold indicates “Replace Battery/Not Operational”. An intermediate voltage threshold indicates “Battery low/needs replacement soon.” A highest voltage threshold indicates that the battery is at an acceptable state of charge, i.e., “OK”. Both the fob module 300 and seat module 100 have an LED (e.g., an RGB LED module) for indicating battery state. By way of example, when either the fob module 300 or seat module 100 battery falls below the lowest set threshold, as determined by the microcontrollers 400, 500, a red LED may blink on whichever device (the fob module 300 and/or seat module 100) has a low battery. As another example, if either the fob module 300 or seat module 100 battery falls below the intermediate set threshold, as determined by the microcontrollers 400, 500, a yellow LED may illuminate on whichever device (the fob module 300 and/or seat module 100) has a battery that may need replacement soon. As yet another example, if either the fob module 300 or seat module 100 battery is at or above the highest set threshold, as determined by the microcontrollers 400, 500, a green LED may illuminate on whichever device (the fob module 300 and/or seat module 100) has a battery at an acceptable charge state. Each LED illumination may be accompanied by a unique beep or no beep. For example, a red LED illuminated for a battery requiring replacement may be accompanied by no beep, while a yellow LED illuminated for a battery that may soon require replacement may be accompanied by a periodic beep for a determined time duration, and a green LED illuminated for a battery that is at an acceptable state of charge may be accompanied by a steady beep for a determined time duration.

To set the communication range, an indication is provided to the devices. By way of example and not limitation, a button (e.g., input devices 420, 505) on each device may be simultaneously pressed, while the devices are in close proximity, for a determined time duration (e.g., 5 seconds), to indicate that range configuration mode should be implemented. Then the buttons may be released and the fob module 300 may be moved to a point (i.e., location) just outside the desired range limit for communication. All points outside the desired range are within an “excessive range.” Then, the button on the seat module 100 may be pressed once. The seat module 100 will then send a test message to the fob module 300 using the highest available output power setting for the transceiver 410. In an exemplary implementation, the transceiver 410 has several (e.g., three) distinct output power settings corresponding to low, intermediate and high. However, transceivers with 2 or more (e.g., Nordic's nRF24L01 transceiver includes 4 power output settings for its power amplifier) settings may be used within the spirit and scope of the invention. If the fob module 300 receives the test message sent at the highest available output power setting, it will transmit a received message to the seat module 100. If the fob module 300 does not send a received message within a determined time, e.g., 2 seconds, after the seat module sends a test message, then the fob module 300 is safely outside of communication range, and the highest power output for transceiver 410 may be set by the seat module 100. If the seat module 100 receives from the fob module 300 a received message for the highest available output power setting, the seat module 100 will then send a test message at the intermediate output power setting for the transceiver 410. If the fob module 300 receives the test message sent at the intermediate output power setting, it will transmit a received message to the seat module 100. If the fob module 300 does not send a received message within a determined time, e.g., 2 seconds, after the seat module sends a test message, then the fob module 300 is safely outside of communication range, and the intermediate power output for transceiver 410 may be set by the seat module 100. If the seat module 100 receives, from the fob module 300, a received message for the intermediate output power setting, the seat module 100 will then send a test message at the lowest output power setting for the transceiver 410. If the fob module 300 receives the test message sent at the lowest output power setting, it will transmit a received message to the seat module 100. If the fob module 300 does not send a received message within a determined time, e.g., 2 seconds, after the seat module sends a test message, then the fob module 300 is safely outside of communication range, and the lowest power output for transceiver 410 may be set by the seat module 100. If the seat module 100 receives, from the fob module 300, a received message for the lowest output power setting, the seat module 100 will then emit an audible and visible alarm, indicating that even at the lowest power output, the fob module 300 remains within communication range of the seat module 100. A user is thus alerted that the fob module 300 should be stored at a more remote location from the seat module 100, to allow proper notification in the event a child is left unattended in a child seat equipped with the buckled seat module 100. The communication range setting process may be repeated for each location desired to be tested.

In an alternative implementation, testing of communication ranges may proceed from the lowest power setting to the highest power setting. The process proceeds as described in the previous paragraph, except that testing begins with the lowest power output setting and continues incrementally, until the power output setting is sufficient to provide a range that reaches the fob module 300. Then the power output is set to the power output setting immediately prior (i.e., immediately lower than) the output setting at which communication is established. In this manner, the setting will be at the lowest effective power output. This not only helps ensure proper operation, but also reduces battery consumption.

Illustratively, DC current consumption at the lowest power output setting may be 7.0 mA, while such consumption at the highest power output setting may be 11.3 mA, and intermediate settings may have DC current consumption values in between 7.0 mA and 11.3 mA, such as 9.0 mA and 7.5 mA for a transceiver with four possible settings. Setting the power output at the lowest effective power output setting can substantially improve battery life while ensuring effective operation.

In use, a child is placed in a child seat and the seat module 100 is closed (i.e., buckled) to initiate a radio monitoring link with the fob module 300. Audible feedback may confirm that the link is active. For example, one beep may indicate that both devices have acceptably charged batteries. Two beeps may mean that one of the devices has a low battery but the link remains active, in which case the LED battery level indicator will reveal each battery that is low. No audible feedback during pairing may mean that one or both of the devices has a depleted battery and link is not active.

When the link is active, if the fob module 300 travels further than the coverage range of the signal emitted by the transceiver 410 of the seat module 100, the fob module 300 produces an alarm that notifies the user that seat module remains closed (i.e., buckled) in the car. The communication range may vary depending on several factors such as the set power output, location of devices and density of signals on public ISM frequency band (2.4 GHZ). A range estimate is 5-15 meters.

The alarm may be terminated in any of a variety of ways. In one implementation, when the fob module 300 returns to within communication range of the seat module 100, the alarm will deactivate. In another implementation, when the fob module 300 returns to within communication range of the seat module 100 and the seat module is opened (i.e., unbuckled), the alarm will deactivate.

When the seat module 100 is opened, both the seat module 100 and fob module 300 enter sleep modes.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A range adjustable child seat alert system for a child seat having a pair of shoulder straps, the range adjustable child seat alert system comprising:
a seat module, the seat module being attachable to a pair of shoulder straps of a child seat, the seat module comprising:
a clasp member including a clasp body with a sideways H-shaped opening for receiving one strap of the pair of straps of the child seat;
a receptacle member in which the clasp member is releasably locked, the receptacle member including a receptacle body with a sideways H-shaped opening for receiving the other strap of the pair of straps of the child seat;
a first circuit attached to the receptacle member, the first circuit including:
a first transceiver having a variable output power;
a first microcontroller operably coupled to the transceiver, the first microcontroller setting an output power for the transceiver, the output power determining an effective range of communication, and the first microcontroller providing messages to be transmitted by the first transceiver; and
a detection device operably coupled to the first microcontroller and detecting when the clasp member is releasably locked in the receptacle member; and
a fob module comprising:
a second circuit including
a second transceiver capable of receiving messages communicated from the first transceiver within the effective communication range;
a second microcontroller operably coupled to the second transceiver, the second microcontroller determining, if a message is received by the second transceiver from the first transceiver within a determined time period, and whether an output should be produced.

2. The range adjustable child seat alert system of claim 1, the first microcontroller setting the output power for an effective communication range that is less than an excessive range indicated by a user.

3. The range adjustable child seat alert system of claim 2, further comprising an input means for indicating the excessive range.

4. The range adjustable child seat alert system of claim 1, the first microcontroller setting the output power for an effective communication range that is less than an excessive range determined by location of the fob module by a user.

5. The range adjustable child seat alert system of claim 4, further comprising an input means for indicating the excessive range.

6. The range adjustable child seat alert system of claim 1, further comprising a first input device operably coupled to the first microcontroller, and a second input device operably coupled to the second microcontroller.

7. The range adjustable child seat alert system of claim 6, the first microcontroller setting the output power for an effective communication range that is less than an excessive range determined by location of the fob module by a user after the first input device and second input device are simultaneously activated.

8. The range adjustable child seat alert system of claim 6, the first input device comprising a first button, and the second input device comprising a second button, and the first microcontroller setting the output power for an effective communication range that is less than an excessive range determined by location of the fob module by a user after the first button and second button device are simultaneously pressed.

9. The range adjustable child seat alert system of claim 1, further comprising an audible alarm device operably coupled to the second microcontroller, the second microcontroller causing the audible alarm device to produce an audible alarm if the clasp member is releasably locked in the receptacle member and the second microcontroller determines that a message is not received by the second transceiver from the first transceiver within the determined time period.

10. The range adjustable child seat alert system of claim 1, the seat module further comprising a first battery operably coupled to the first microcontroller, and the first microcontroller determining a charge state for the first battery, and
the fob module further comprising a second battery operably coupled to the second microcontroller, and the second microcontroller determining a charge state for the second battery.

11. The range adjustable child seat alert system of claim 10, the seat module further comprising a first RGB light emitting diode assembly operably coupled to the first microcontroller, and the first RGB light emitting diode assembly indicating the charge state for the first battery, and
the fob module further comprising a second RGB light emitting diode assembly operably coupled to the second microcontroller, and the second RGB light emitting diode assembly indicating the charge state for the second battery.

12. A child seat equipped with a range adjustable child seat alert system, the child seat having a pair of shoulder straps, the range adjustable child seat alert system comprising a seat module and a fob module:
the seat module comprising:
a clasp member including a clasp body with a sideways H-shaped opening receiving a first strap of the pair of straps of the child seat;
a receptacle member in which the clasp member is releasably locked, the receptacle member including a receptacle body with a sideways H-shaped opening receiving a second strap of the pair of straps of the child seat;
a first circuit attached to the receptacle member, the first circuit including:
a first transceiver having a variable output power;
a first microcontroller operably coupled to the transceiver, the first microcontroller setting an output power for the transceiver, the output power determining an effective range of communication, and the first microcontroller providing messages to be transmitted by the first transceiver; and
a detection device operably coupled to the first microcontroller and detecting when the clasp member is releasably locked in the receptacle member; and
the fob module comprising:
a second circuit including
a second transceiver capable of receiving messages communicated from the first transceiver within the effective communication range;
a second microcontroller operably coupled to the second transceiver, the second microcontroller determining, if a message is received by the second transceiver from the first transceiver within a determined time period, and whether an output should be produced.

13. The child seat equipped with a range adjustable child seat alert system of claim 12, the first microcontroller setting the output power for an effective communication range that is less than an excessive range indicated by a user.

14. The child seat equipped with a range adjustable child seat alert system of claim 13, further comprising an input means for indicating the excessive range.

15. The child seat equipped with a range adjustable child seat alert system of claim 12, the first microcontroller setting the output power for an effective communication range that is less than an excessive range determined by location of the fob module by a user.

16. The child seat equipped with a range adjustable child seat alert system of claim 15, further comprising an input means for indicating the excessive range.

17. The child seat equipped with a range adjustable child seat alert system of claim 12, further comprising a first input device operably coupled to the first microcontroller, and a second input device operably coupled to the second microcontroller.

18. The child seat equipped with a range adjustable child seat alert system of claim 17, the first microcontroller setting the output power for an effective communication range that is less than an excessive range determined by location of the fob module by a user after the first input device and second input device are simultaneously activated.

19. The child seat equipped with a range adjustable child seat alert system of claim 17, the first input device comprising a first button, and the second input device comprising a second button, and the first microcontroller setting the output power for an effective communication range that is less than an excessive range determined by location of the fob module by a user after the first button and second button device are simultaneously pressed.

20. The child seat equipped with a range adjustable child seat alert system of claim 12, further comprising an audible alarm device operably coupled to the second microcontroller, the second microcontroller causing the audible alarm device to produce an audible alarm if the clasp member is releasably locked in the receptacle member and the second microcontroller determines that a message is not received by the second transceiver from the first transceiver within the determined time period.
